(19) United States
(12) Patent Application Publication
(10) Pub. No.: US 2013/0191104 A1
(43) Pub. Date: Jul. 25, 2013

(54) SYSTEM, METHOD AND COMPUTER PROGRAM PRODUCT FOR MODELING ELECTRONIC CIRCUITS

(71) Applicants: Vladimir Ceperic, Zagreb (HR); Adrijan Baric, Zagreb (HR)

(72) Inventors: Vladimir Ceperic, Zagreb (HR); Adrijan Baric, Zagreb (HR)

(21) Appl. No.: 13/353,701

(22) Filed: Jan. 19, 2012

(51) Int. Cl. G06F 17/50

(52) U.S. Cl. 703/14

(57) ABSTRACT

A system, method and computer program product for modeling electronic circuits via a sparse solution, or a sparse representation of a recurrent single or multi kernel support vector regression machine is provided. In one embodiment, the sparse representation may be attained, for example, by limiting a number of training data points for the method involving support vector regression. Each training data point may be selected based on the accuracy of a non-recurrent or fully recurrent model using an active learning principle applied to the non-successive or successive (time domain) data. A training time may be adjusted, for example, by (i) selecting how often one or more hyperparameters are optimized; or (ii) limiting the number of iterations of the method and consequently the number of support vectors.

### BACKGROUND OF THE INVENTION

The present invention relates, in general, to generating models for electronic circuits, and more particularly to behavioral models using support vector machines, and structures thereof.

For modeling an electronic device or a circuit, a small size of the model, in other words, a sparse model, results in a faster execution of a modeling tool for simulation in a hardware description language, such as Verilog A. Several approaches have been made for generating the sparse models. Some approaches are: relevance vector machines (RVM), adaptive sparse supervised learning (ASSL), kernelized least absolute shrinkage and selection operator regression (KLASSO), and fixed-size least squares support vector machines (FS-LSSVM). All these models may achieve high accuracy to complexity ratio. However, they are generally not designed for time-domain modeling or for recurrent models that are needed for modeling of electronic devices or electronic circuits.

It may be desirable to maintain the non-linear input-output circuit behavior, but simulate faster than the original net list, have an automatic implementation of a behavioral model into a high level analog description language, ensure highly reliable convergence in a circuit simulator, and provide fast execution due to compactness of the generated model. Some embodiments of the present invention may provide one or more of these advantages.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and implementations or embodiments shown. In the drawings:

FIG. 1 is a method of modeling, such as an electronic circuit or a component, in accordance with an example embodiment of the present invention;

FIG. 2 is a portion of the method of FIG. 1 in accordance with an example embodiment of the present invention;

FIG. 3 illustrates another portion of the method of FIG. 1 in accordance with an example embodiment of the present invention;

FIG. 4 illustrates another portion of the method of FIG. 1 in accordance with an example embodiment of the present invention;

FIG. 5 illustrates still another portion of the method of FIG. 1 in accordance with an example embodiment of the present invention;

FIG. 6 is a block diagram of a device in accordance with an example embodiment of the present invention;

FIG. 7 is a portion of the block diagram of the device of FIG. 6 in accordance with an example embodiment of the present invention;

FIG. 8 illustrates another portion of the block diagram of the device of FIG. 6 in accordance with an example embodiment of the present invention;

FIG. 9 illustrates still another portion of the block diagram of the device of FIG. 6 in accordance with an example embodiment of the present invention; and

FIG. 10 illustrates a system having a computer and a storage medium in accordance with an example embodiment of the present invention.

For simplicity and clarity of the illustration, elements in the figures are not necessarily to scale, are only schematic and are non-limiting, and the same reference numbers in different figures denote the same elements, unless stated otherwise. Additionally, descriptions and details of well-known steps and elements are omitted for simplicity of the description. It will be appreciated by those skilled in the art that the words “during”, “while”, and “when” as used herein relating to circuit operation are not exact terms that mean an action takes place instantly upon an initiating action but that there may be some small but reasonable delay, such as a propagation delay, between the reaction that is initiated by the initial action. Additionally, the term “while” means that a certain action occurs at least within some portion of a duration of the initiating action. The use of the word “approximately” or “substantially” means that a value of an element has a parameter that is expected to be close to a stated value or position. However, as is well known in the art there are always minor variances that may prevent the values or positions from being exactly as stated. When used in reference to a state of a signal, the term “asserted” means an active state of the signal and inactive means an inactive state of the signal. The terms “first”, “second”, “third” and the like in the Claims or/and in the Detailed Description, are used for distinguishing between similar elements and not necessarily for describing a sequence, either temporally, spatially, in ranking or in any other manner. It is to be understood that the terms so used are interchangeable under appropriate circumstances and that the embodiments described herein are capable of operation in other sequences than described or illustrated herein.

Lines and arrows connecting various blocks may show one or more arrowheads or none. The presence or absence of the arrowheads does not indicate any particular sequence or direction of signals or information unless otherwise specified.

### DETAILED DESCRIPTION

In the following description, for purposes of explanation and not limitation, specific details are set forth, such as particular signals, circuits, circuit arrangements, thresholds, components, operation modes, algorithms, software, techniques, protocols, hardware arrangements, either internal or external, etc., in order to provide a thorough understanding of the present invention.

However, it will be apparent to one skilled in the art that the present invention may be practiced in other embodiments that depart from these specific details. Detailed descriptions of well-known signals, circuits, thresholds, components, algorithms, software, operation modes, techniques, protocols, and hardware arrangements, either internal or external, etc., are omitted so as not to obscure the description.

As is known to those skilled in the art, a support vector machine (SVM) is a concept applicable in computer science and statistics for a set of related supervised learning methods that analyze data and recognize patterns, often used for classification and regression analysis. Typically, the standard SVM takes a set of input data and predicts, for each given input, which of two possible classes comprises the input. Given a set of training data, each marked as belonging to one of two categories, an SVM training algorithm builds a model that may assign new data into one category or the other. An SVM model is a representation of the examples as points in space, mapped so that the examples of the separate categories are divided by a clear gap that is as wide as possible. New examples are then mapped into that same space and predicted to belong to a category based on which side of the gap they fall on.

A specific type of SVM is called support vector regression (SVR). The model produced by SVR depends only on a subset of the training data, because the cost of building the model ignores any training data that is close to the model prediction (within a predetermined threshold).

Embodiments of the present invention may comprise method for modeling electronic circuits via a sparse solution, or a sparse representation of a recurrent and non-recurrent support vector regression machine. The method may achieve a high accuracy vs. complexity and may allow a user to adjust a complexity of a resulting model. The sparse representation may be attained, for example, by limiting a number of training data points for the method involving support vector regression. Each training data point may be selected based on the accuracy of a fully recurrent model using an active learning principle applied to the successive time domain data. A training time may be adjusted, for example, by (i) selecting how often one or more hyperparameters are optimized; or (ii) limiting the number of iterations of the method and consequently the number of support vectors. Some embodiments of the present invention may reduce the number of support vectors and significantly improve the accuracy vs. complexity of the recurrent support vector regression machine.

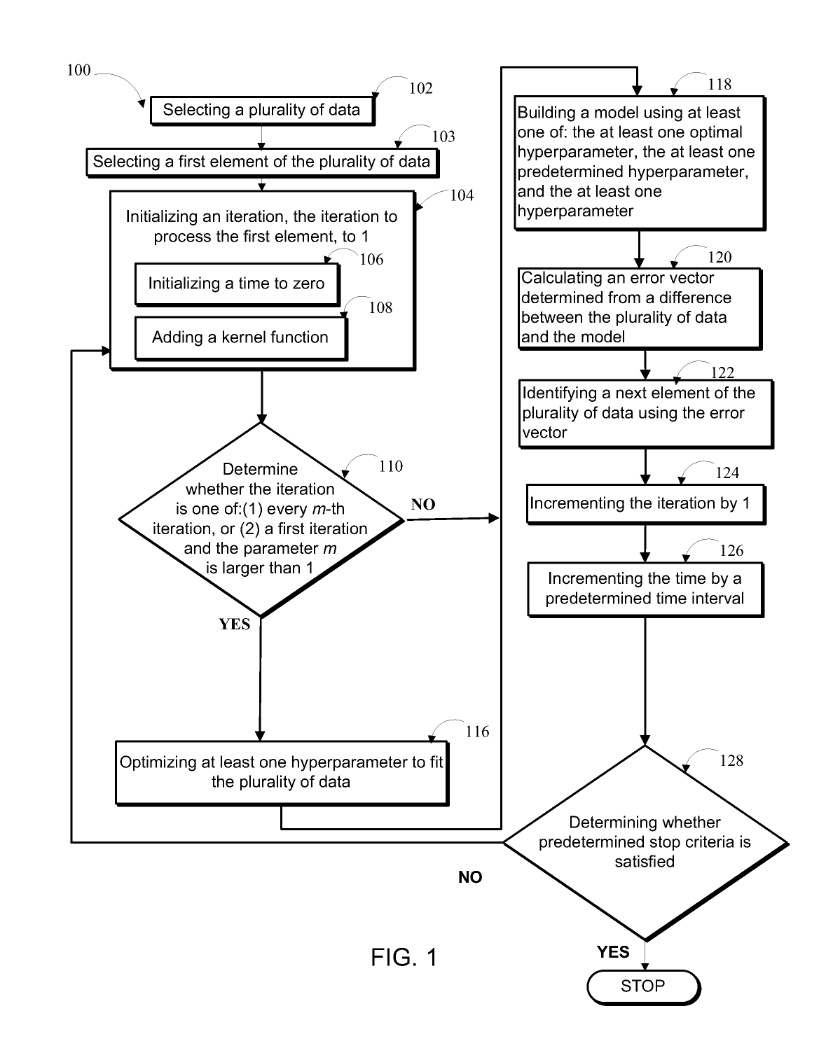

FIG. 1 illustrates an example embodiment of a method 100 of the present invention. The method 100 may include selecting a plurality of data at 102 (the overall training data set), selecting a first element of the current training data set at 103 wherein the first element may be selected as soon as the first element is available for processing and there may be little need to wait for another element to become available for processing. At 104, the process may include initializing an iteration to process the first element, to 1. At 110 the process may include determining whether the iteration is one of: (1) an every m-th iteration, or (2) a first iteration and the parameter m is larger than 1. At 116 the process may include optimizing at least one hyperparameter to fit the plurality of data and building a model using at least one of: the at least one optimal hyperparameter, the at least one predetermined hyperparameter, and the at least one hyperparameter at 118. The process may include calculating an error vector determined from a difference between the plurality of data and the model at 120 and identifying another element of the plurality of data using the error vector at 122. At 124 the process may include incrementing the iteration by 1 and testing whether a predetermined stop criterion is satisfied at 128. If the predetermined stop criterion is not satisfied at 128, the process includes repeating processes 108-126.

The method 100 may be termed an ALSVR (Active Learning for Support Vector Regression) for building a sparse model with support vector regression by active learning where the user may select when to optimize the hyperparameters and thus directly influence overall training time and model accuracy. There also are other methods of influencing the overall training time and accuracy, such as, for example, by limiting model complexity by selecting the number of the iterations of the method. The selection of the optimal SVR hyperparameters also may be embedded into a training algorithm. The ALSVR may optimize the SVR every m-th iteration where m is a positive integer number.

In an embodiment of the method 100, the initializing the iteration to 1 may include, for example, adding a kernel function at 108. If more than one kernel function is used, this may be considered an implementation of a multikernel active learning support vector regression (MK-ALSVR). It may be noted that if a kernel or multikernel functionality is not desired, the method 100 may be implemented without adding a kernel function.

The MK-ALSVR may include preprocessing the plurality of data by a nonlinear mapping and then applying a linear regression. Stated differently, the MK-ALSVR may have two layers: (i) a nonlinear preprocessing layer. In each iteration of the ALSVR, one kernel function may be added to the model. One or more hyperparameters of the kernel function may be optimized using a particle swarm optimization (PSO) algorithm (although other optimization algorithms may be used instead); and (ii) a linear, c-tube SVR layer, as implemented in LIBSVM tool known in the art. One or more c-tube SVR hyperparameters may be optimized using the PSO algorithm.

The hyperparameters of the ALSVR, TD-ALSVR (discussed below), and MK-ALSVR may be defined automatically by an embodiment of the method 100 via an optimization on the overall training data set or the current training data set (CTDS). CTDS is meant to refer to the current training data set used and generated by the method and is different from the overall training data set. Typical excitation signals that may be selected by the user (that may be used to generate the overall training data set) may be a sine wave having amplitude modulation, a frequency modulated sine wave, and a clock signal having varying rise time, fall time, and clock frequency. Other excitation signals may be selected as well. The type of the excitation signal may depend on the circuit or the component that is modeled and an intended usage of the circuit or the component. The excitation signal may preferably cover substantially the whole domain of possible inputs with respect to frequency and amplitude. If the user does not select (or other input) a specific excitation signal, then a frequency modulated sinusoid may be used as a default.

In an embodiment of the method 100, the initializing the iteration to 1 may further (or alternately) include initializing a time to zero at 106 and wherein the incrementing the iteration by 1 may further include incrementing the time by a predetermined time interval at 126. Initializing the time to zero may be an example of an implementation of time domain active learning support vector regression (TD-ALSVR).

For a special case when m=1, the TD-ALSVR may transform into a variant called Optimized Hyperparameters for Time Domain Active Learning recurrent Support Vector Regression (OH-TASVR). OH-TASVR may be termed a sparse c-SVR-based algorithm for the training and construction of a recurrent model, such as a model having a feedback, where the active learning principle is used with the optimization of the SVM hyperparameters in each iteration of the algorithm, i.e., m=1. This may be very time consuming if a necessary number of support vectors is large. On the other hand, an iterative optimization of the hyperparameters may attain a near-optimal model for the CTDS.

For a special case when m is very large, the TD-ALSVR may transform into a variant called Initially Determined Hyperparameters Active Learning recurrent Support Vector Regression (IDH-TASVR). In an embodiment of the method 100, the initializing the iteration to 1 at 104 may further include setting the parameter m to a predetermined larger number. m may be set to infinity or >100, for example. IDH-TASVR may be termed a sparse ε-SVR algorithm for the training and construction of the recurrent model where the hyperparameters may be set in a first step and later kept fixed in subsequent training steps, i.e., m=∞. It may be noted that for large m (e.g., m≧100), the quality of an initially chosen hyperparameters may significantly deteriorate when a training process proceeds, if the initially chosen hyperparameters are determined on a limited training data set. In such cases, it may be preferable to select the hyperparameters based on the plurality of data using a series-parallel configuration either by cross-validation, or by experience, or by a trial-and-error procedure in a first iteration of the algorithm. IDH-TASVR may be more suitable when a necessary number of support vectors for a preferred model accuracy is significant or when a faster training time is preferred over a small loss in the preferred model accuracy. In IDH-TASVR, the optimization of the hyperparameters may be performed only once and same hyperparameters may then be used in each iteration of the training algorithm.

In either of the TASVR (e.g., IDH-TASVR or OH-TASVR), a new element of the plurality of data may be added to the CTDS in each iteration. The next element to be included in the CTDS may be determined by a performance of the model on the CTDS sequence from a first point in the CTDS to the last point of the time axis. The performance of the model may be limited to the end of the time axis because the model may be built preferably based on information prior to the last point in the time axis. The next element to be included in the CTDS may be selected in a limited time axis, Δt forward from the current point in time. The point in the limited time axis which contributes the most to the performance of the model may be included in the CTDS.

It may be noted that if a time domain functionality is not desired, an embodiment of the method 100 may be implemented without the processes 106 and 126.

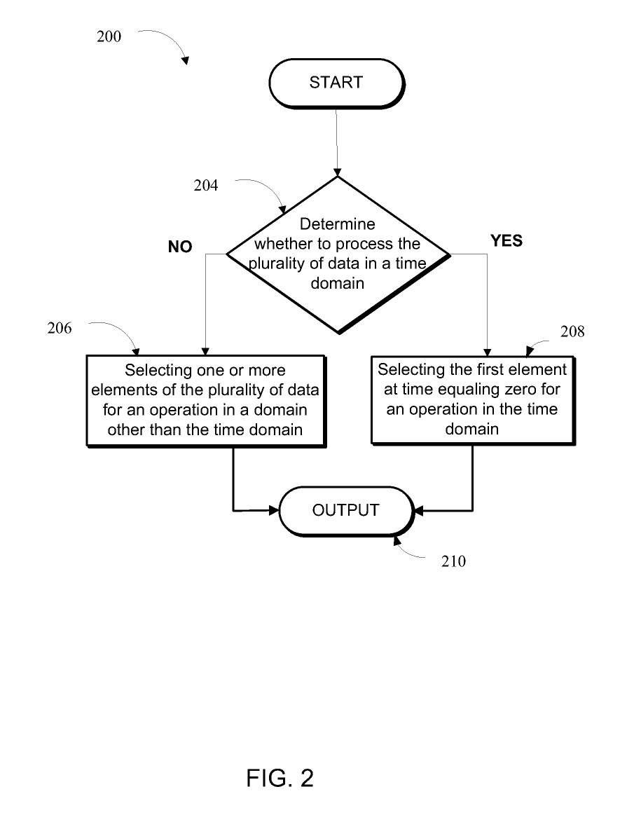

FIG. 2 illustrates a portion of the method 100 in accordance with an example embodiment of the present invention. In an embodiment, method 200 describes some examples of processes that may comprise process 103 of the method 100 shown in FIG. 1. After the selecting the first element of the plurality of data (103 of FIG. 1), the method 200 may include determining whether to process the plurality of data in a time domain at 204. If at 204 it is determined to process in the time domain, the process 200 may include selecting the first element at time equaling zero for an operation in the time domain at 208. If at 204 it is determined to not process the plurality of data in the time domain, the process 200 may include selecting one or more elements of the plurality of data for an operation in a domain other than the time domain at 206. The selected elements are output from either 206 or 208 at 210. The selecting the first element of the plurality of data may be based on a type of method or algorithm, such as ALSVR, or MK-ALSVR, or TD-ALSVR. In the selecting the first element at time equaling zero for an operation in the time domain, a first input-output pair (at time=0) may be used.

In the case of ALSVR and MK-ALSVR, a procedure for the selection of the first or more elements of the plurality of data, such as the CTDS, may be based on: minimum or maximum value of the output, a random selection, a user experience, trial-and-error, cross-validation, etc. The selection of an initial CTDS may include: [1] identifying four outputs with highest values and corresponding inputs; [2] identifying one input-output pair selected from the pool identified in [1]; [3] building the ALSVR model or the MK-ALSVR model and calculating the mean square error (MSE) on the full plurality of data; [4] repeating [2] and [3] until all selected input-output pairs are tested; and [5] the input-output pairs that build the model with the smallest MSE may be selected as an initial CTDS.

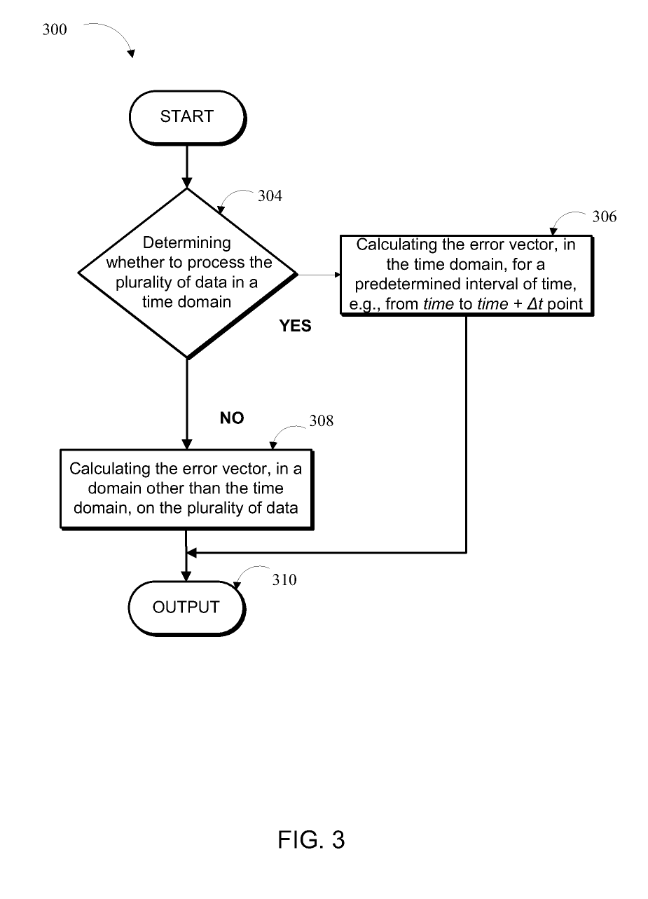

FIG. 3 illustrates another portion of the method 100 in accordance with an example embodiment of the present invention. In an example embodiment, the method 300 describes some examples of processes that may comprise process (calculating an error vector) of the method 100 shown in FIG. 1. The calculating the error vector may further include determining whether to process the plurality of data in a time domain at 304. If it is determined to process the plurality of data in the time domain at 304, the method 300 may include calculating the error vector, in the time domain, for a predetermined interval of time at 306. The predetermined interval of time may be from a point of time t to a t+Δt point. If it is determined to not process the plurality of data in the time domain at 304, the method 300 may include calculating the error vector, in a domain other than the time domain, on the plurality of data at 308. An output is obtained at 310. In one scenario, in the case of the TD-ALSVR, the error vector may be calculated from the plurality of data from the point of time t to the point of time t+Δt. In another scenario, in the case of the ALSVR and MK-ALSVR, the error vector may be calculated over the full training data set.

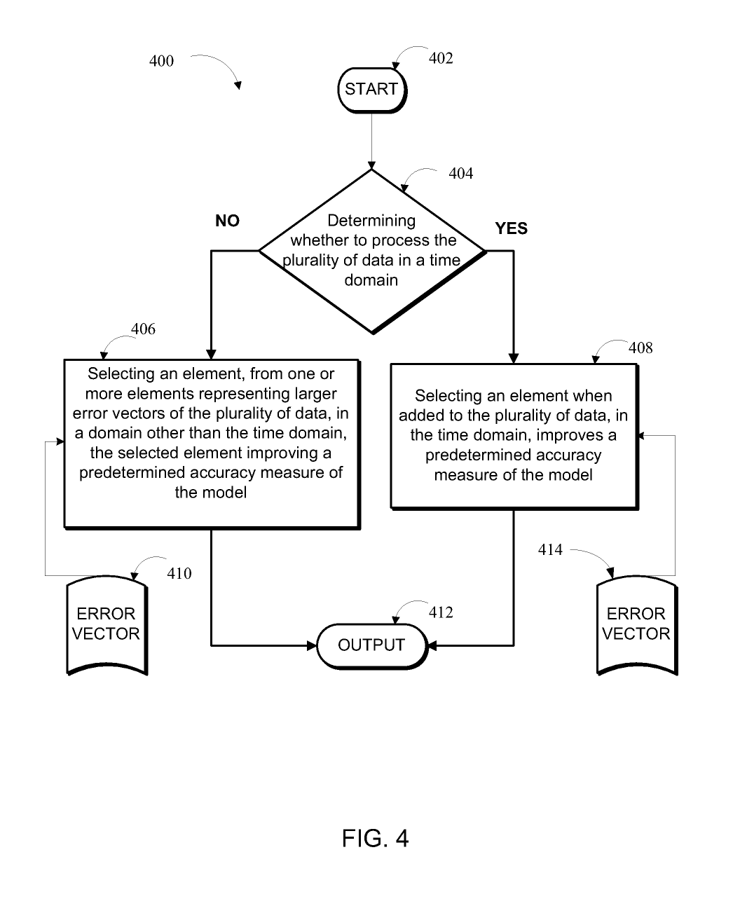

FIG. 4 illustrates another portion of the method 100 in accordance with an example embodiment of the present invention. In an example embodiment, the method 400 describes some examples of processes that may comprise process 122 of the method 100 shown in FIG. 1. The identifying the next element may include determining whether to process the plurality of data in a time domain at 404. If it is determined to process the plurality of data in the time domain at 404, the method 400 may include selecting an element that when added to the plurality of data in the time domain, improves an accuracy measure of the model at 408. If it is determined to not process the plurality of data in the time domain at 404, the method 400 may include selecting an element, from one or more elements representing larger error vectors of the plurality of data, in a domain other than the time domain, and wherein the selected element improves an accuracy measure of the model at 406. One or more error vectors may be introduced in the time domain at 414 and in a domain other than the time domain at 410. The accuracy measure of the model may be represented by a point attributed to least value of an error vector. An output is obtained at 412.

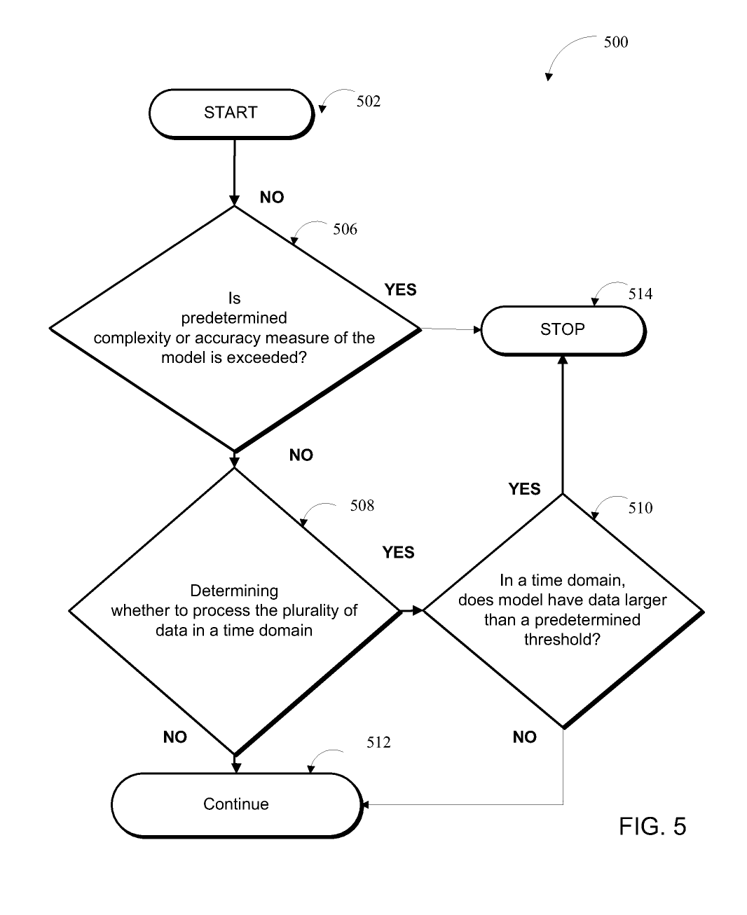

FIG. 5 illustrates still another portion of the method 100 in accordance with an example embodiment of the present invention. In an embodiment, the method 500 describes some examples of processes that may comprise process 128 of the method 100 shown in FIG. 1. The determining whether predetermined stop criteria is satisfied include one or more of: determining whether a predetermined complexity or accuracy measure of the model is exceeded at 506 and, if so, stopping at 514 and if not determining whether to process the plurality of data in a time domain at 508 and if so determining in a time domain processing, whether the model has data larger than a predetermined threshold at 510; and, if not, continuing in a domain other than the time domain to 104 of FIG. 1 at 512 (and if so stopping at 514). As shown in FIG. 5, the method processes through processes 506, 508, and 512 on a negative decision. A stoppage happens at 514 as a consequence of a positive decision at any of processes 506 or the combination of 508 and 510.

In an embodiment of the method 100, the selecting the plurality of data may include selecting the plurality of data substantially as soon as the plurality of data is generated. In an embodiment of the method 100, the plurality of data may be a current training data set (CTDS) and is different from the overall training data set. It may be noted that in the ALSVR, an addition of a new element of the plurality of data to the CTDS may be accomplished in each iteration. A next element to be included in the CTDS may be determined by a performance of the model on the plurality of data, i.e., by using an active learning principle. The element (or elements) that will be tested to be included in CTDS may be selected from an area where the performance of the model is worst. The element (or elements) from this selection that contribute most to the model accuracy may be selected to be included in CTDS.

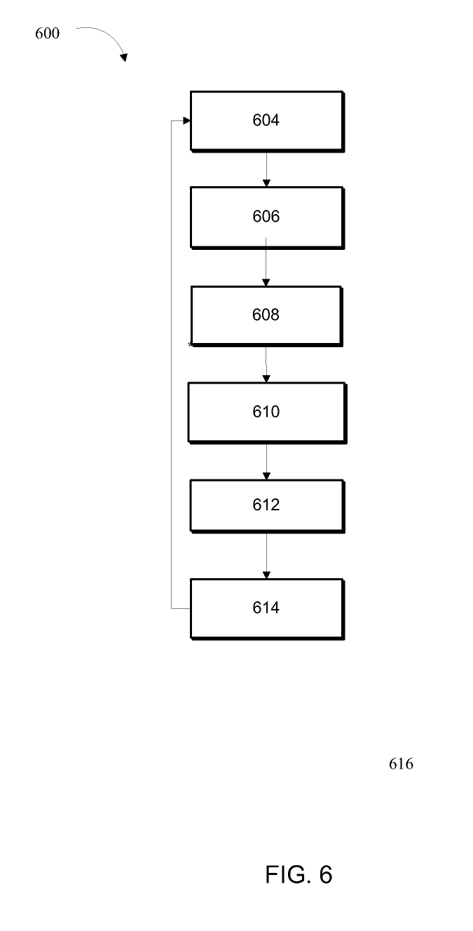

FIG. 6 is a block diagram of a device 600 in accordance with an example embodiment of the present invention. An embodiment of the device 600 may include a first processor 604 configured to set at least one modeling parameter, a second processor 606 configured to fetch a plurality of modeling data, the second processor 606 being connected to the first processor 604, a third processor 608 configured to preprocess each element of the modeling data, the third processor 608 being connected to the second processor 606, a fourth processor 610 configured to build a model, the fourth processor 610 being connected to the third processor 608, and the fourth processor 610 being configured to process a current training data set selected from an output of the third processor 608, a postprocessor 612 configured to rescale in a predetermined manner an output of the fourth processor 610, the postprocessor 612 being connected to the fourth processor 610, a model verifier, the model verifier being connected to the postprocessor, the first processor, the model verifier being configured to direct an output of the model verifier to the first processor if one of the following criteria is not met: (i) a predetermined model accuracy criterion and (ii) a predetermined model complexity criterion, and the model verifier being configured to direct the output of the model verifier if the predetermined model accuracy criterion and the predetermined model complexity criteria is satisfied. If the method is operating in the time domain, it would be determined whether there are any remaining data points to process. If not, the procedure may stop. In other embodiments, processors 604-614 may instead comprise program code executable by a processor to perform the described functionality.

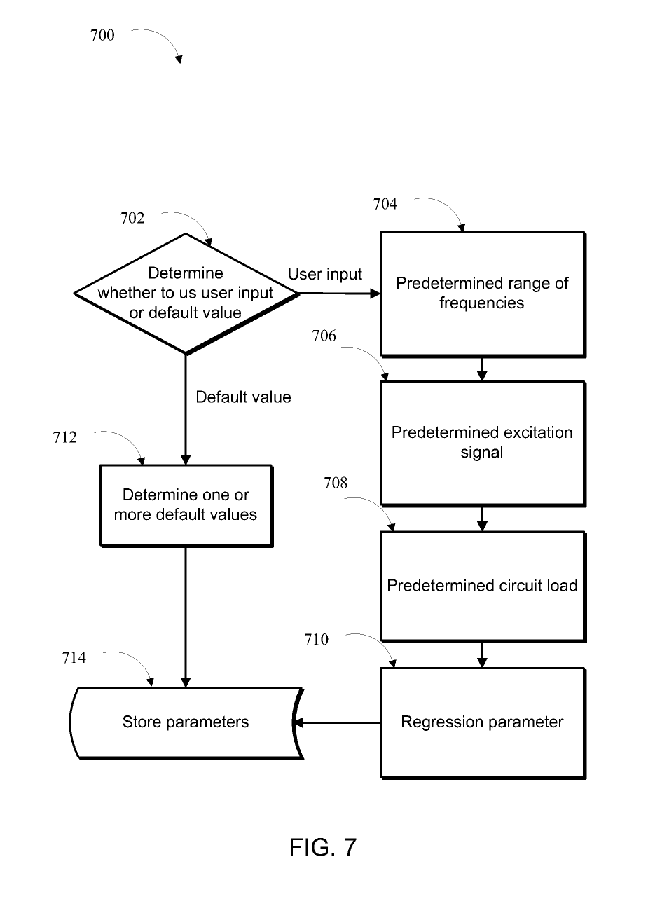

FIG. 7 is a flow diagram of an example embodiment of a portion 700 of the device 600 in accordance with an example embodiment of the present invention. More specifically, the functionality of the flow diagram of FIG. 7 provides an example of the operation of one embodiment of the first processor 604. As illustrated, at 702 the operation may include determining whether to use (and process) a user input or a default value. If it is determined to process the user input, at 704 the process includes determining the one or more predetermined range of frequencies of the user input, the predetermined excitation signal at 706, the circuit load at 708, and one or more regression parameters at 710. If at 702 it is determined to process the default values, the process may include retrieving and processing the one or more default values from a memory. Processing of the user input (processes 704-710) and the default value (process 712) may generate one or more stored parameters at 714.

A user may supply an input (e.g., parameters) to generate the training data set, e.g., frequency range, excitation signal parameters, circuit load during training, maximum number of support vectors, and optimization parameters, based on an intended use of the model, the type of circuit load, and a desired accuracy.

Regarding the intended use of the model, if the model is not to be used in a frequency range beyond 1 GHz, for example, there may be little need that the excitation signal in the training phase has a frequency beyond 1 GHz. Similarly, if the typical predetermined circuit load is in the range of 1-2 mega ohms, then there may be little need to vary the predetermined circuit load outside of this range. Also, if a circuit being modeled by the device 600 operates in a supply voltage range of 3.3 V+/−10%, there may be little need to apply supply voltages outside the supply voltage range. Regarding the type of circuit load, there may be little need to use a recurrent version of the algorithm (TD-ALSVR) if there is no feedback in the circuit. Although the TD-ALSVR algorithm may be used and may work, an improvement in results may be unlikely in an absence of the feedback. The predetermined accuracy measure of the model may be controlled by the maximum number of support vectors.

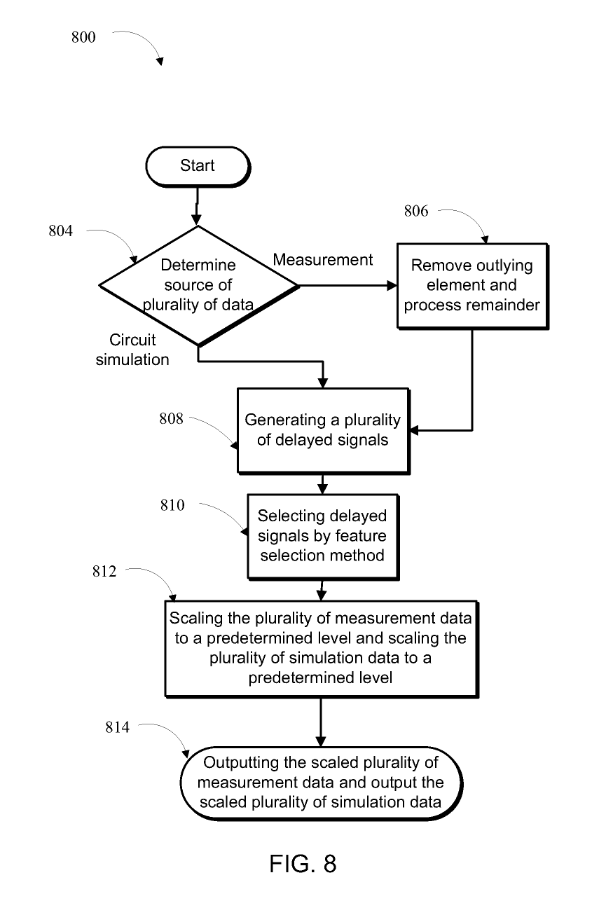

FIG. 8 illustrates a flow diagram of an example embodiment of a portion 800 of the operation of the device 600 in accordance with an example embodiment of the present invention. More specifically, the flow diagram of FIG. 8 provides an example embodiment of the operation of the third processor 608 of FIG. 6. After determining the source of the plurality of data (process 804), the third processor 608 may be configured to remove an outlying element of a plurality of (measurement) data (if the source is measurement) and process the remainder of the plurality of measurement data at 806. If the source is determined at 804 to be circuit simulation, the process may include generating a plurality of delayed signals at 806 (which is also performed after processing the measurement data at 806. The process 800 may continue with selecting a plurality of generated delayed signals by feature selection method at 810). At 812 the process may include scaling the plurality of (measurement) data to a predetermined level or scaling the plurality of simulation data to a predetermined level and outputting the scaled plurality of measurement data, and output the scaled plurality of simulation data at 814.

It may be noted that the third processor 608 may be further configured to remove an outlying element of a plurality of measurement data, such as the outlying element generated from a noisy measurement. A standard procedure may be used for removing the outlying element, e.g., by using the distance to k-nearest neighbors to label or define a measurement as an outlying element or as a non-outlying element.

Regarding the generation of a plurality of delayed signals, the input may be expanded to include one or more delayed versions of the input. This may be accomplished manually, i.e., a number of delayed inputs and their delays may be set by the user, or automatically. For example, if the user did not specify the number of delayed inputs, twenty incrementally delayed versions of each input may be generated by default. A unit delay step may be equal to a default time step of the data from measurement or the data from simulation.

Regarding the selection of the delayed signals by the feature selection method, in one embodiment only a limited number of the one or more delayed versions of the input may be selected. The selection may be manual (i.e., the one or more delayed versions of the input may be selected by the user) or automated. In the case of the automated selection, the selection may be used to select the one or more delayed versions of the input that contribute more to the predetermined model accuracy criterion. A standard feature selection algorithm, e.g., a relief algorithm, may be used. Regarding the scaled plurality of measurement data and the scaled plurality of simulation data, the data may be scaled into a range (e.g., [−1, 1]). The user may use some other scaling, e.g., the scaled plurality of measurement data and the scaled plurality of simulation data may be mapped to have a mean value equal to zero and a standard deviation equal to one.

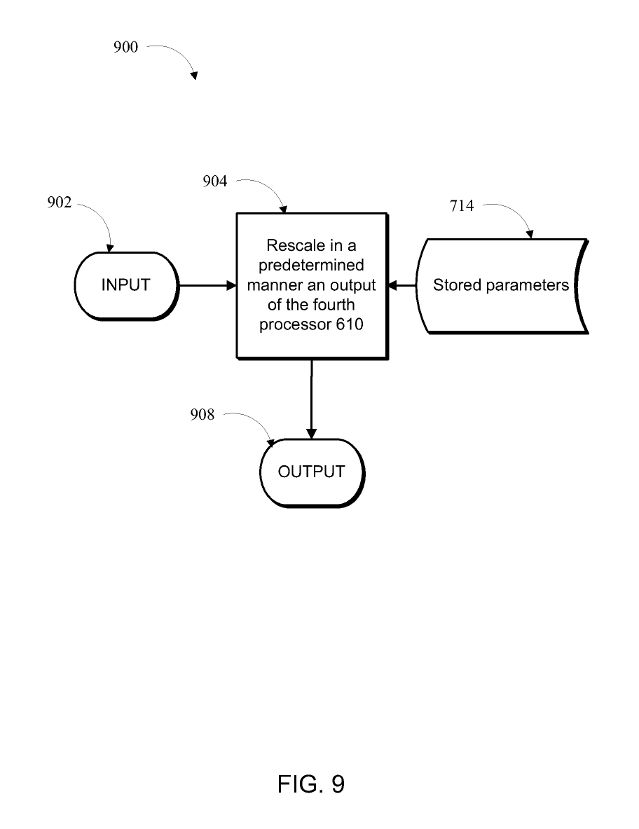

FIG. 9 illustrates a flow diagram that represents an example embodiment of the operation of the postprocessor 612 of device 600 in accordance with an example embodiment of the present invention. The postprocessor 612 may receive input from 902 and one or more stored parameters from 714 (from FIG. 7) and rescale in a predetermined manner an output of the fourth processor 610 at 904) to generate an output 908. The rescaling in the predetermined manner may be a reversion to the scale of the scaled plurality of measurement data and the scaled plurality of simulation data discussed above.

In an example embodiment of the device 600, the fourth processor 610 may be further configured to iteratively process each element of the current training data set and further configured to initialize an iteration to 1 and determine whether the iteration is one of: a first iteration, an m-th iteration, and a late iteration, the late iteration being larger than a predetermined threshold iteration, and if so, determine at least one optimal hyperparameter by cross-validation on at least a part of the plurality of data, The fourth processor 610 may further be configured to build a model using at least one of: the at least one optimal hyperparameter, the at least one predetermined hyperparameter, and the at least one hyperparameter; calculate an error vector determined from a difference between the plurality of data and the model, (g) identify a next element of the plurality of data using the error vector, (h) increment the iteration by 1, (i) determine whether a predetermined stop criteria is satisfied, and repeat these processes if the predetermined stop criteria is not satisfied and otherwise stop.

In an embodiment of the device 600, the fourth processor 610 also may be further configured to add a kernel function. In an embodiment of the device 600, the fourth processor 610 may be further configured to increment the iteration by 1, initialize a time to zero, and increment the time by a predetermined time interval. In an embodiment of the device 600, the fourth processor 610 may be further configured to determine whether to process the plurality of data in a time domain, calculate the error vector, in the time domain, for a predetermined interval of time, and calculate the error vector, in a domain other than the time domain, on the plurality of data.

In an embodiment of the device 600, the fourth processor 610 also may be further configured to determine whether to process the plurality of data in a time domain, select an element when added to the plurality of data, in the time domain, improves a predetermined accuracy measure of the model, select an element, from one or more elements representing larger values of error vectors of the plurality of data, in a domain other than the time domain, the selected element improving a predetermined accuracy measure of the model. The predetermined accuracy measure of the model may be an element of the plurality of data attributed to the least value of error vector.

In an embodiment of the device 600, the fourth processor 610 also may be further configured to perform the functionality of FIG. 5.

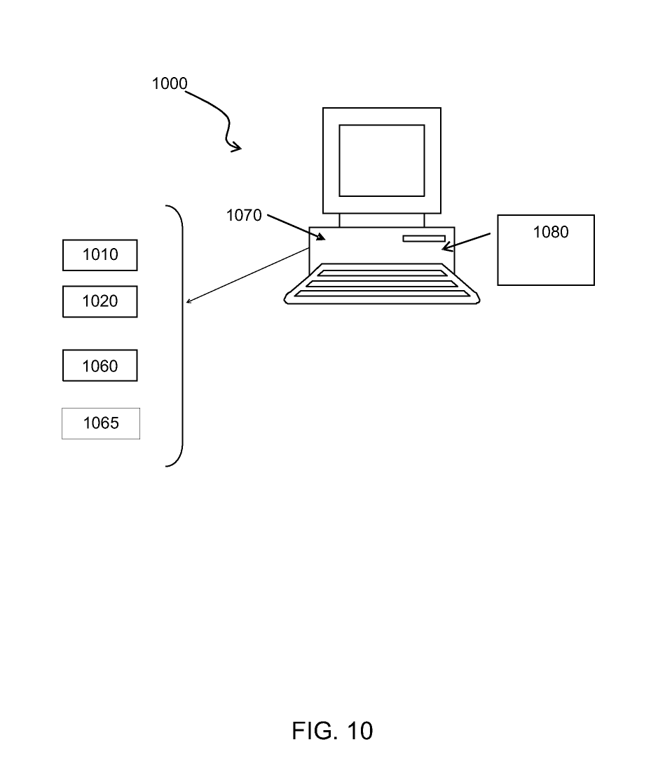

FIG. 10 illustrates an embodiment of a computer system 1000 having a computer 1070 and a storage medium 1080 that may embody an example embodiment of the present invention. The storage medium 1080 may comprise transitory memory and non-transitory memory. The computer system 1000 may comprise one or more additional computers such as computers 1010, 1020 all of which may be in communication with each other (and co-located or distributed) and with an output device 1060, the Internet, and one or more networks 1065 and communicatively connected to a cloud computing environment.

Embodiments of the present invention may be formed of a computer program product stored on one or more non-transitory computer-readable storage medium, such as an embodiment of the storage medium 1080, that includes computer-executable instructions for performing the processes described herein.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention.

As the claims hereinafter reflect, inventive aspects may lie in less than all features of a single foregoing disclosed embodiment. Thus, the hereinafter expressed claims are hereby expressly incorporated into this Detailed Description, with each claim standing on its own as a separate embodiment of an invention. Furthermore, while some embodiments described herein include some but not other features included in other embodiments, combinations of features of different embodiments are meant to be within the scope of the invention, and form different embodiments, as would be understood by those skilled in the art.

What is claimed is:

1. A method of modeling of circuit, comprising:
selecting a plurality of data;
selecting a first element of a current training data set;
initializing an iteration, the iteration to process the first element, to 1;
(a) determining whether the iteration is one of: an m-th iteration or a first iteration and the parameter m is larger than one;
(d) optimizing, when the iteration is the m-th iteration, at least one hyperparameter to current training data set;
(c) building a model using at least one selected from the group of: at least one optimal hyperparameter, at least one predetermined hyperparameter, and at least one hyperparameter;
(d) calculating an error vector determined from a difference between the plurality of data and the model;
(e) identifying a next element of the plurality of data using the error vector;
(f) incrementing the iteration;
(g) determining whether a predetermined stop criteria is satisfied and if so, outputting a result; and
repeating (a) through (g) if the predetermined stop criteria is not satisfied.

2. The method of claim 1, wherein said initializing the iteration to one further comprises adding a kernel function.

3. The method of claim 1, wherein said initializing the iteration to one comprises initializing a time to zero and wherein said incrementing the iteration comprises incrementing the time by a predetermined time interval.

4. The method of claim 1, wherein said initializing the iteration to one comprises setting the iteration to a predetermined larger number.

5. The method of claim 1, wherein said selecting the first element comprises:
determining whether to process the plurality of data in a time domain;
selecting the first element at time equaling zero for an operation in the time domain if it is determined to process the plurality of data in the time domain; and
selecting one or more elements of the plurality of data for an operation in a domain other than the time domain if it is determined to not process the plurality of data in the time domain.

6. The method of claim 1, wherein said calculating the error vector comprises:
determining whether to process the plurality of data in a time domain;
calculating the error vector in the time domain for a predetermined interval of time if it is determined to process the plurality of data in a time domain; and
calculating the error vector in a domain other than the time domain on the plurality of data if it is determined to not process the plurality of data in a time domain.

7. The method of claim 1, wherein said identifying the next element comprises:
determining whether to process the plurality of data in a time domain;
if it is determined to process the plurality of data in a time domain, selecting an element when added to the plurality of data, in the time domain, improves an accuracy measure of the model; and
if it is determined to not process the plurality of data in a time domain, selecting an element, from one or more elements representing larger error vectors of the plurality of data, in a domain other than the time domain, the selected element improving an accuracy of the model.

8. The method of claim 1, wherein the determining whether stop criteria is satisfied comprises at least one of:
determining whether a predetermined complexity measure of the model is exceeded; and
determining whether the model has data larger than a predetermined threshold.

9. The method of claim 1, wherein said selecting the plurality of data further comprises selecting the plurality of data substantially as soon as the plurality of data is generated.

10. The method of claim 1, wherein the plurality of data is a current training data set (CTDS).

11. A computer program product, comprising a non-transitory computer usable medium having a computer readable program code embodied therein, said computer readable program code adapted to be executed to implement a method for modeling a circuit, said method comprising:
selecting a plurality of data;
selecting a first element of a current training data set;
initializing an iteration, the iteration to process the first element, to 1;
(a) determining whether the iteration is one of: an m-th iteration or a first iteration and the parameter m is larger than one;
(d) optimizing, when the iteration is the m-th iteration, at least one hyperparameter to current training data set;
(c) building a model using at least one selected from the group of: at least one optimal hyperparameter, at least one predetermined hyperparameter, and at least one hyperparameter;
(d) calculating an error vector determined from a difference between the plurality of data and the model;
(e) identifying a next element of the plurality of data using the error vector;
(f) incrementing the iteration by 1;
(g) determining whether a predetermined stop criteria is satisfied and if so, outputting a result; and
repeating (a) through (g) if the predetermined stop criteria is not satisfied.

12. The computer program product of claim 11, wherein said initializing the iteration to one comprises adding a kernel function.

13. The computer program product of claim 11, wherein said initializing the iteration to one comprises initializing a time to zero and wherein said incrementing the iteration by one comprises incrementing the time by a predetermined time interval.

14. The computer program product of claim 11, wherein said initializing the iteration to one comprises setting the iteration to a predetermined larger number.

15. The computer program product of claim 11, wherein said selecting the first element comprises:
determining whether to process the plurality of data in a time domain;
selecting the first element at time equaling zero for an operation in the time domain if it is determined to process the plurality of data in the time domain; and
selecting one or more elements of the plurality of data for an operation in a domain other than the time domain if it is determined to not process the plurality of data in the time domain.

16. The computer program product of claim 11, wherein said calculating the error vector comprises:
determining whether to process the plurality of data in a time domain;
calculating the error vector in the time domain for a predetermined interval of time if it is determined to process the plurality of data in a time domain; and
calculating the error vector in a domain other than the time domain on the plurality of data if it is determined to not process the plurality of data in a time domain.

17. The computer program product of claim 11, wherein said identifying the next element comprises:
determining whether to process the plurality of data in a time domain;
if it is determined to process the plurality of data in a time domain, selecting an element when added to the plurality of data, in the time domain, improves a accuracy measure of the model; and
if it is determined to not process the plurality of data in a time domain, selecting an element, from one or more elements representing larger error vectors of the plurality of data, in a domain other than the time domain, the selected element improving a predetermined accuracy measure of the model.

18. The computer program product of claim 11, wherein said determining whether stop criteria is satisfied comprises at least one of:
determining whether a predetermined complexity measure of the model is exceeded; and
determining whether the model has data larger than a predetermined threshold.

19. A computer program product stored in a non-transitory computer-readable storage medium having computer-executable instructions executable by a processor to perform a method for modeling a circuit, comprising:
a code segment to select a plurality of data;
a code segment to select a first element of a current training data set;
a code segment to initialize an iteration to process the first element to 1;
a code segment to determine whether the iteration is one of: an m-th iteration or a first iteration and the parameter m is larger than one;
a code segment to optimize, when the iteration is the m-th iteration, at least one hyperparameter to the current training data set;
a code segment to build a model using at least one selected from the group of: at least one optimal hyperparameter, at least one predetermined hyperparameter, and at least one hyperparameter;
a code segment to calculate an error vector based on a disparity between the plurality of data and the model;
a code segment to identify a next element of the plurality of data based on the error vector;
a code segment to increment the iteration; and
a code segment to determine whether a predetermined stop criteria is satisfied and if so, to output a result.

20. The computer program product of claim 19, wherein said code segment to select the first element comprises a code segment to:
determine whether to process the plurality of data in a time domain;
select the first element at time equaling zero for an operation in the time domain if it is determined to process the plurality of data in the time domain; and
select one or more elements of the plurality of data for an operation in a domain other than the time domain if it is determined to not process the plurality of data in the time domain.
